(19) United States
(12) Patent Application Publication
(10) Pub. No.: US 2008/0133610 A1
(43) Pub. Date: Jun. 5, 2008

(54) METHOD AND APPARATUS FOR TRACKING DIRECTORY FOR FILE TRANSFER PROGRAM

(75) Inventors: Chang Hee JUNG, Daejeon (KR); Duk Kyun Woo, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 11/949,446

(22) Filed: Dec. 3, 2007

(30) Foreign Application Priority Data
Dec. 5, 2006 (KR) 2006-0122250
Feb. 27, 2007 (KR) 2007-0019472

(51) Int. Cl. G06F 12/00

(52) U.S. Cl. 707/200; 707/E17.01

(57) ABSTRACT

Provided are an apparatus and method for tracking a directory, in which a final running directory path is transferred to a file transfer program through a terminal emulator. The method includes the steps of: (a) outputting a directory path request command in use to a terminal emulator; (b) receiving a current directory path output from the terminal emulator in response to the directory path request command; and (c) outputting the received current directory path to a file transfer program. Therefore, a path of a final running directory is transferred to a file transfer program through a terminal emulator to automatically set a directory path where the file transfer program is uploaded/downloaded when the file transfer program is executed.

### CROSS-REFERENCE TO RELATED APPLICATION

This application claims priority to and the benefit of Korean Patent Application No. 2006-0122250, filed Dec. 5, 2006, and No. 2007-0019472, filed Feb. 27, 2007, the disclosure of which is incorporated herein by reference in its entirety.

### BACKGROUND

1. Field of the Invention

The present invention relates to an apparatus and method for tracking a directory, and more particularly, to an apparatus and method for tracking a directory for a file transfer program co-operating with a terminal emulator.

2. Discussion of Related Art

Generally, when a user edits a program source file of a server system at a remote site, a terminal emulator is used. When the user edits a program source file, a data file of the program that is being edited may be uploaded to a server, depending on the circumstances. At this time, the user may upload the data file to the server using a file transfer program. In addition, the user may search out a specific file by accessing a server system at a remote site using a terminal emulator, and the user may download a desired file to a user terminal using a file transfer program.

Meanwhile, when a user runs the file transfer program for file upload and download, the user should move the program to a directory that is running on the terminal emulator. That is, although the user moves to a directory where a desired file is to be transferred on the terminal emulator, the user should move again to the directory to be transferred on the file transfer program. Since such a search procedure starts from a root directory, when the directory that is subjected to the search has a deep link, the directory does not facilitate the search. For example, when a user works on a “C:\windows\linux\solaris” directory of a server system using a terminal emulator and executes a file transfer program, the directory for the file transfer program starts from the root directory “C:\”. Consequently, the user should search for a directory where the emulator does a final operation, using a mouse, etc., and then move to the directory.

### SUMMARY OF THE INVENTION

The present invention is directed to an apparatus and method for automatically transferring a directory path where a final operation is done through a terminal emulator, such that a user does not need to manually search for a directory path.

One aspect of the present invention provides a method of tracking a directory including the steps of: (a) outputting a directory path request command in use to a terminal emulator; (b) receiving a current directory path output from the terminal emulator in response to the directory path request command; and (c) outputting the received current directory path to a file transfer program.

Another aspect of the present invention provides an apparatus for tracking a directory including: a path request unit for outputting a directory path request command in use to a terminal emulator; a path receiver for receiving a current directory path output from the terminal emulator in response to the directory path request command to output the received current directory path to a path setup unit; and the path setup unit for receiving the current directory path output from the path receiver to output the received path to a file transfer program.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a block diagram illustrating the configuration of an apparatus for tracking a directory according to an exemplary embodiment of the present invention;

FIG. 2 illustrates a program source of the apparatus for tracking a directory according to an exemplary embodiment of the present invention;

FIG. 3 is a flowchart illustrating a method of tracking a directory according to an exemplary embodiment of the present invention; and

FIG. 4 illustrates a method of tracking a directory when a plurality of emulators are used according to an exemplary embodiment of the present invention.

### DETAILED DESCRIPTION OF EMBODIMENTS

The present invention will now be described more fully hereinafter with reference to the accompanying drawings, in which exemplary embodiments of the invention are shown. This invention may, however, be embodied in different forms and should not be construed as limited to the exemplary embodiments set forth herein.

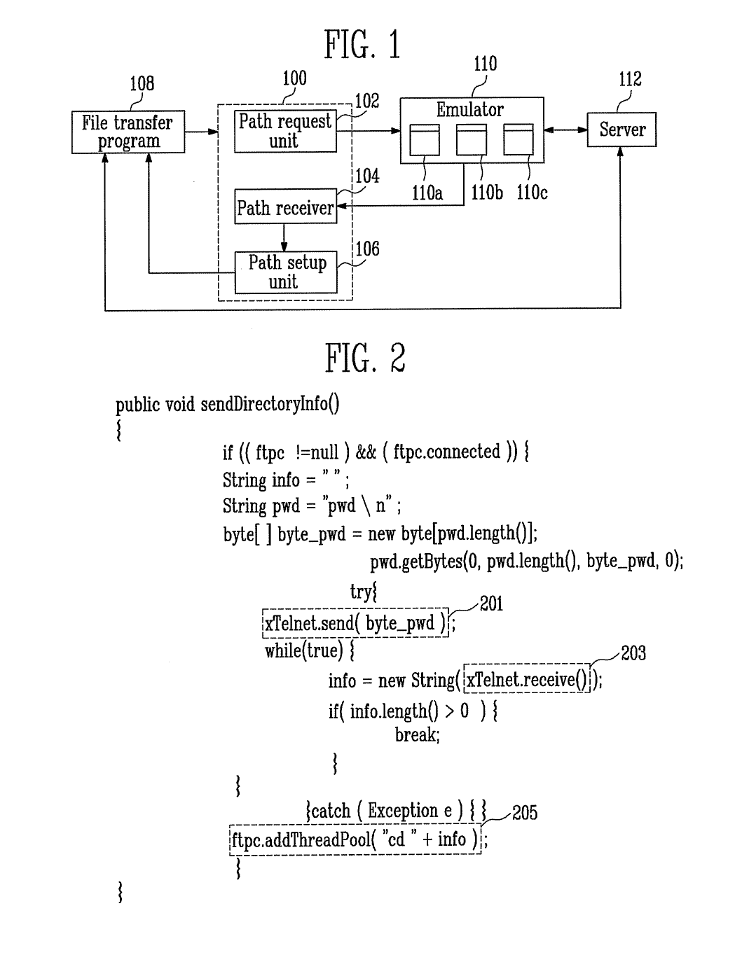

FIG. 1 is a block diagram illustrating the configuration of an apparatus for tracking a directory 100 according to an exemplary embodiment of the present invention, and FIG. 2 illustrates a program source of the directory tracking apparatus 100 according to an exemplary embodiment of the present invention. The configuration and operation of the directory tracking apparatus 100 of the present invention will be described below with reference to FIGS. 1 and 2.

The directory tracking apparatus 100 according to an exemplary embodiment of the present invention includes a path request unit 102, a path receiver 104 and a path setup unit 106.

The path request unit 102 outputs a directory path request command to a terminal emulator 110, when a file transfer program 108 is executed. The present invention may be applied to a file transfer program based on various file transfer protocols such as File Transfer Program (FTP), TELetype NETwork (TELNET), Secure Shell (SSH), etc. Here, when a plurality of terminal emulators 110a, 110b and 110c run and the terminal emulator 110a is the final running emulator (a detailed description of the invention will be described below with reference to the final running terminal emulator 110a), the path request unit 102 outputs the directory path request command to the terminal emulator 110a. Accordingly, the terminal emulator 110a that receives the directory path request command outputs a path extract command to a server 112. Then, the server 112 outputs the path in use to the terminal emulator 110a according to the path extract command. Referring to FIG. 2, “xTelnet send( byte_pwd )” corresponding to 201 of FIG. 2 denotes a directory path extract command output to the server 112.

After receiving the current directory path output from the terminal emulator 110a, the path receiver 104 outputs the current directory path to the path setup unit 106. Referring to FIG. 2, “xTelnet.receive( )” corresponding to 203 of FIG. 2 denotes a directory path receive command output from the server 112.

The path setup unit 106 outputs the current directory path received from the path receiver 104 to the file transfer program 108. Referring to FIG. 2, “ftpc.addThreadPool (“cd”+info )” corresponding to 205 of FIG. 2 denotes a command for outputting the current directory path to the file transfer program 108. The file transfer program 108 sets a path to be uploaded/downloaded as the current directory path output from the path setup unit 106.

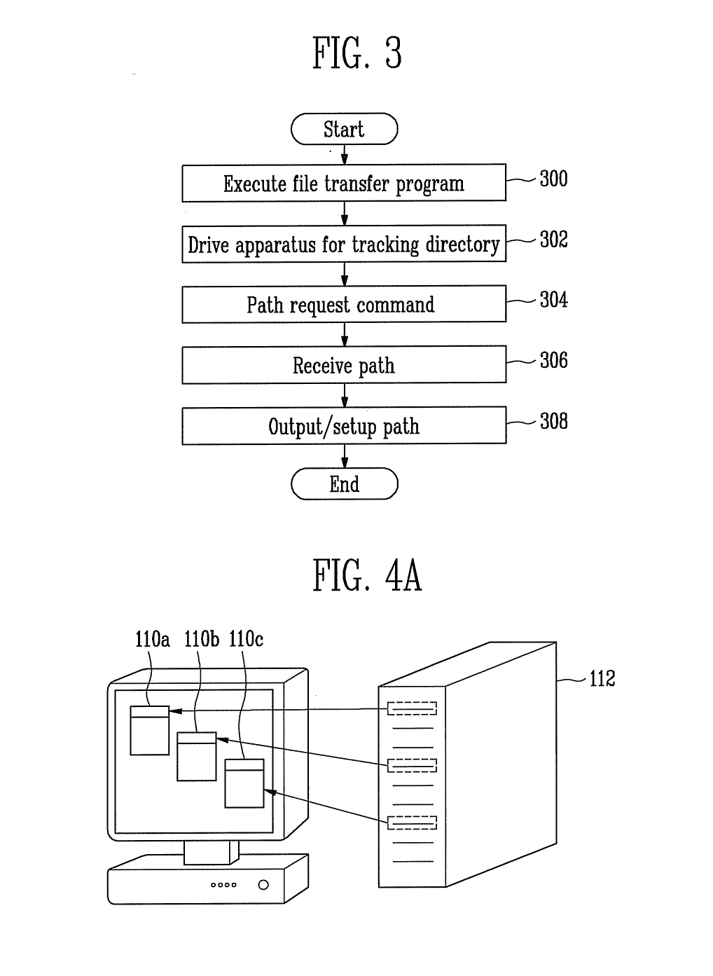

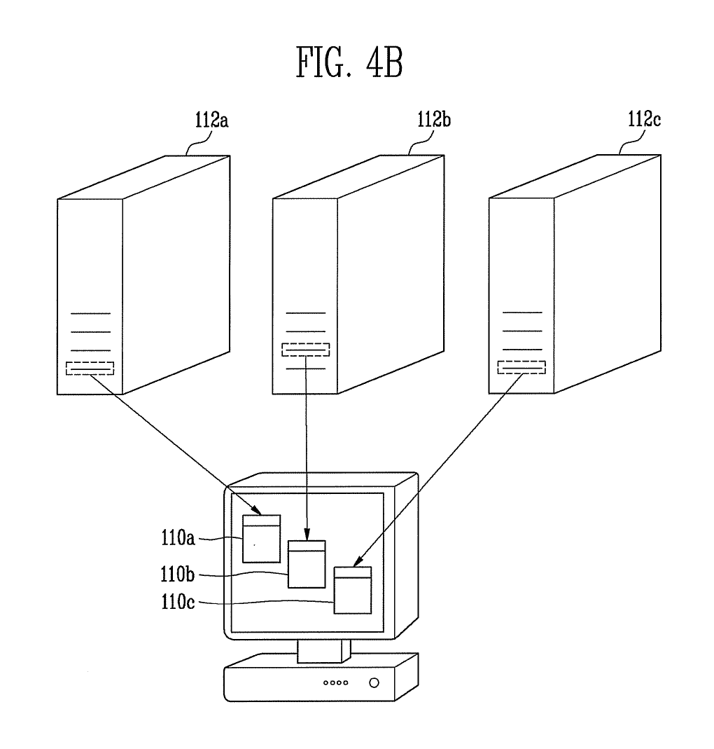

FIG. 3 is a flowchart illustrating a method of tracking a directory according to an exemplary embodiment of the present invention, and FIG. 4 illustrates a method of tracking a directory using a plurality of emulators according to an exemplary embodiment of the present invention. The method of tracking a directory of the present invention will be described in detail below with reference to FIGS. 3 and 4.

When a file transfer program 108 is executed in steps 300 and 302, an apparatus for tracking a directory 100 is driven accordingly.

The directory tracking apparatus 100 outputs a path request command to a terminal emulator 110 in step 304. Here, a case when a plurality of terminal emulators 110a, 110b and 110c are running will be described below with reference to FIG. 4. When a user edits a program by accessing a server 112 using a plurality of terminal emulators 110a, 10b and 110c in a terminal (FIG. 4A) and a file transfer program 108 is executed, the directory tracking apparatus 100 outputs the path request command to the final running terminal emulator 110a. In addition, when the user edits a program by accessing a plurality of servers 112a, 112b and 112c using the plurality of terminal emulators 110a 110b and 110c (FIG. 4B) in a terminal, it also outputs the path request command to the terminal emulator 110a.

When the path request command is received from the directory tracking apparatus 100, the terminal emulator 110 outputs a path extract command to the server 112. Then, the server 112 outputs the current running directory path to the terminal emulator 110 according to the path extract command.

After the path receiver 104 receives the current directory path output from the terminal emulator 110 in step 306, it outputs the current directory path to the path setup unit 106.

The path setup unit 106 outputs the current directory path received from the path receiver 104 to the file transfer program 108 in step 308. The file transfer program 108 sets a path of a directory to be uploaded/downloaded according to the current directory path output from the path setup unit 106. When a directory where the file transfer program 108 is to be uploaded/downloaded is setup, the file transfer takes place through a connection to the server 112.

As described above, the final running directory path is automatically transferred to a file transfer program through a terminal emulator, so that a user does not need to manually search for a path of a directory where an executing file transfer program is uploaded/downloaded. Also, when a plurality of terminal emulators are running, a directory path of the final running terminal emulator is transferred to the file transfer program. In addition, the final running directory path may be set as a path where the file transfer program will be uploaded/downloaded through the terminal emulator.

Exemplary embodiments of the invention are shown in the drawings and described above in specific terms. However, no part of the above disclosure is intended to limit the scope of the overall invention. For example, the present invention is applicable by changing a parameter of a program irrespective of an operation system (Windows/Unix/Linux/MacOS) of a server. It will be understood by those of ordinary skill in the art that various changes in form and details may be made to the exemplary embodiments without departing from the spirit and scope of the present invention as defined by the following claims.

What is claimed is:

1. A method of tracking a directory, comprising the steps of:
(a) outputting a directory path request command in use to a terminal emulator;
(b) receiving a current directory path output from the terminal emulator in response to the directory path request command; and
(c) outputting the received current directory path to a file transfer program.

2. The method of claim 1, wherein step (a) comprises outputting the current running directory path request command to a finally executed terminal emulator when a plurality of terminal emulators are executed.

3. The method of claim 1, further comprising the step of (d) setting a path where the file transfer program is to be uploaded or downloaded as the received current directory path.

4. The method of claim 3, wherein the file transfer program is one of file transfer programs based on a File Transfer Program (FTP) protocol, a TELetype NETwork (TELNET) protocol and a Secure Shell (SSH) protocol.

5. An apparatus for tracking a directory, comprising:
a path request unit for outputting a directory path request command in use to a terminal emulator;
a path receiver for receiving a current directory path output from the terminal emulator in response to the directory path request command to output the received current directory path to a path setup unit; and
the path setup unit for receiving the current directory path output from the path receiver to output the received path to a file transfer program.

6. The apparatus of claim 5, wherein the path request unit outputs the current running directory path request command to a finally executed terminal emulator when a plurality of terminal emulators are executed.

7. The apparatus of claim 5, wherein a path where the file transfer program is to be uploaded/downloaded is set as the current directory path received from the path setup unit.

8. The apparatus of claim 7, wherein the file transfer program is one of file transfer programs based on an FTP protocol, a TELNET protocol and an SSH protocol.
